(19) United States
(12) Patent Application Publication
(10) Pub. No.: US 2011/0153393 A1
(43) Pub. Date: Jun. 23, 2011

(54) SYSTEM AND METHOD FOR MONITORING AND INCREASING SALES AT A CASH REGISTER

(76) Inventors: Einav Raff, Tel Aviv (IL); John H. Bauman, Brooklyn, NY (US); Ronen Mendel, Kfar Saba (IL); Yaron Pe`er, Tel Aviv (IL)

(21) Appl. No.: 12/819,788

(22) Filed: Jun. 21, 2010

Related U.S. Application Data
(60) Provisional application No. 61/219,343, filed on Jun. 22, 2009.
(60) Provisional application No. 61/219,708, filed on Jun. 23, 2009.

(51) Int. Cl. G06Q 30/00

(52) U.S. Cl. 705/7.42; 705/14.65

(57) ABSTRACT

The present invention includes a Point-of-Sale and/or Customer Relationship Management system, which can be used to increase sales by providing an offer to a purchaser using data relating to the purchaser, the purchase, or any other relevant data. The offer can be shown to a purchaser on a display with or without sound. Further, the present invention can also be used to promote new products or services, provide additional advertising or promotions that may or may not be a targeted best-fit at these locations, and measure the sales and up-selling at these locations and/or provide a platform for training employees to better sell, up-sell and promote their respective products and services. Further, the data can be read in from the Point-of-Sale system or any other relevant source and can be analyzed and then displayed based on rules and a weighted scale.

### CROSS-REFERENCE TO RELATED APPLICATIONS

This application claims priority to U.S. Provisional Patent Applications No. 61/219,343 filed Jun. 22, 2009 and U.S. Provisional Patent Applications No. 61/219,708 filed Jun. 23, 2009, the content of which are incorporated herein by reference in their entirety.

### FIELD OF THE INVENTION

The present invention generally relates to administering offers to customers, and in particular to a system and method that provides targeted offers to customers to increase sales at a Point-of-Sale; promote and introduce new products and services; provide additional offers based on data affiliated with customer(s) and/or purchaser(s); capture data and measure the statistics of sales and accepted offers; and provide a platform for training employees to better sell, have offers accepted and promote their respective products and services.

### SUMMARY OF THE INVENTION

In exemplary embodiments, the present invention can be directed to a system for monitoring and increasing sales comprising a computer processor, a database stored in a processor readable memory including images, video and/or audio corresponding to offers, a processor readable memory containing computer-readable instructions executable on the computer processor for associating an image targeted to a purchase or order, a Point-of-Sale for receiving a purchase or order, an input/output device, and a display for displaying the targeted images for the purchase or order.

In exemplary embodiments, a method for processing orders at a Point-of-Sale device can comprise, providing a Point-of-Sale Device that can include an order entry system that can receive orders; a processor that can process data related to orders, and at least one display that may face the purchaser. An order can be entered using the order entry system and the order can be analyzed to determine at least one offer that can be displayed on the display or other displays to the customer and may also be displayed on another display or displays to the cashier or customer service or sales agent, and the like.

In exemplary embodiments, the offer can be an up sell, advertisement, new product or service, information and/or promotion.

In exemplary embodiments, the offer can be determined using a weighed scale algorithm and/or a rules based decision algorithm.

In exemplary embodiments, the weighed scale algorithm and/or rules based decision algorithm can group a predetermined number of offers based on purchaser data, purchase data, relative times between offers, public records, and/or private records. In exemplary embodiments, the offer displayed can be selected from a group of a predefined number of offers by determining the best fit and/or the offer displayed can be selected from a group of a predefined number of offers by selecting randomly from the group of a predefined number of offers.

In exemplary embodiments, the weighed scale algorithm and/or rules based decision algorithm can determine which offer to display by analyzing the relative display time of offers to determine what offer to display to the customer.

Further, the weighed scale algorithm and/or rules based decision algorithm can determine which offer to display by analyzing display times of offers and information pertaining to the type of purchase/good.

In exemplary embodiments, the offer acceptance data can be generated relative to whether or not a purchaser accepted the offer. Further, the offer acceptance data can be analyzed to modify the weighed scale algorithm and/or rules based decision algorithm.

In exemplary embodiments, the offer can include a sound generated to get a purchasers attention. In exemplary embodiments, the offer can include video and/or audio content to attract the customers attention.

In exemplary embodiments, at least one additional display can be included and the at least one additional display can face a cashier and can display the offer to the cashier. For example a first display can face the customer and an additional display may face the cashier.

In exemplary embodiments, data affiliated with the order and/or the offer can be analyzed, by a processor, to provide statistical data relating to at least one of a plurality of orders and a plurality of offers. In exemplary embodiments, data affiliated with the order and/or the offer can be analyzed to increase purchases. In exemplary embodiments, data affiliated with the order and/or the offer can be analyzed, by a processor, and this analyzed data can be used to update the weighed scale algorithm and/or rules based decision algorithm. Further, the data can be analyzed using statistical data, data from a third party, and/or purchase.

In exemplary embodiments, data affiliated with the order and/or the offer can be analyzed to determine a cashier's performance in having products purchased.

In exemplary embodiments, the method for processing orders can further include establishing a predetermined threshold for a set number of purchases in a set amount of time between a plurality of purchases at the Point-of-Sale device; analyzing the number of purchases and the time between a plurality of purchases to determine if the predetermined threshold has been exceeded; and wherein when the threshold is exceeded the Point-of-Sale device stops displaying offers based on orders.

In exemplary embodiments, the rules based decision algorithm can determine the type of offer and the weighted scale algorithm can determine the number of times the offer is displayed.

### BRIEF DESCRIPTION OF THE DRAWINGS

The features and advantages of the present invention will be more fully understood with reference to the following, detailed description of illustrative embodiments of the present invention when taken in conjunction with the accompanying figures, wherein:

FIG. 1 is a block diagram of certain components of the system and methods in accordance with exemplary embodiments of the present invention;

FIG. 2 is a flow chart illustrating a Point-of-Sale System and a Customer Relationship Management system in accordance with exemplary embodiments of the present invention;

FIG. 3 is a flow chart illustrating a Point-of-Sale System in accordance with exemplary embodiments of the present invention; and

FIG. 4 illustratively depicts a plurality of displays in accordance with embodiments of the present invention.

### DETAILED DESCRIPTION

The present invention includes a Point-of-Sale (POS) and/or Customer Relationship Management (CRM) system, which can be used to increase sales by providing offer(s) to purchaser(s) using data relating to the purchaser, the purchase, or any other relevant data from any reasonable data source. For example, at a Point-of-Sale system a purchaser can have an offer shown to them, on a display with or without sound, based on data relating to the purchaser and/or the purchase.

The present invention can also be used to promote new products or services; provide additional advertising or promotions that may or may not be a targeted best-fit at these locations; and measure the sales and accepted offers at these locations and/or provide a platform for training employees more effectively sell and promote products and/or services, as well as have offers accepted. Further, data can be read in from the Point-of-Sale system or any other relevant source and this data can be analyzed, for example, a weighed scale algorithm and/or rules based decision algorithm to determine what offer will be shown to a purchaser.

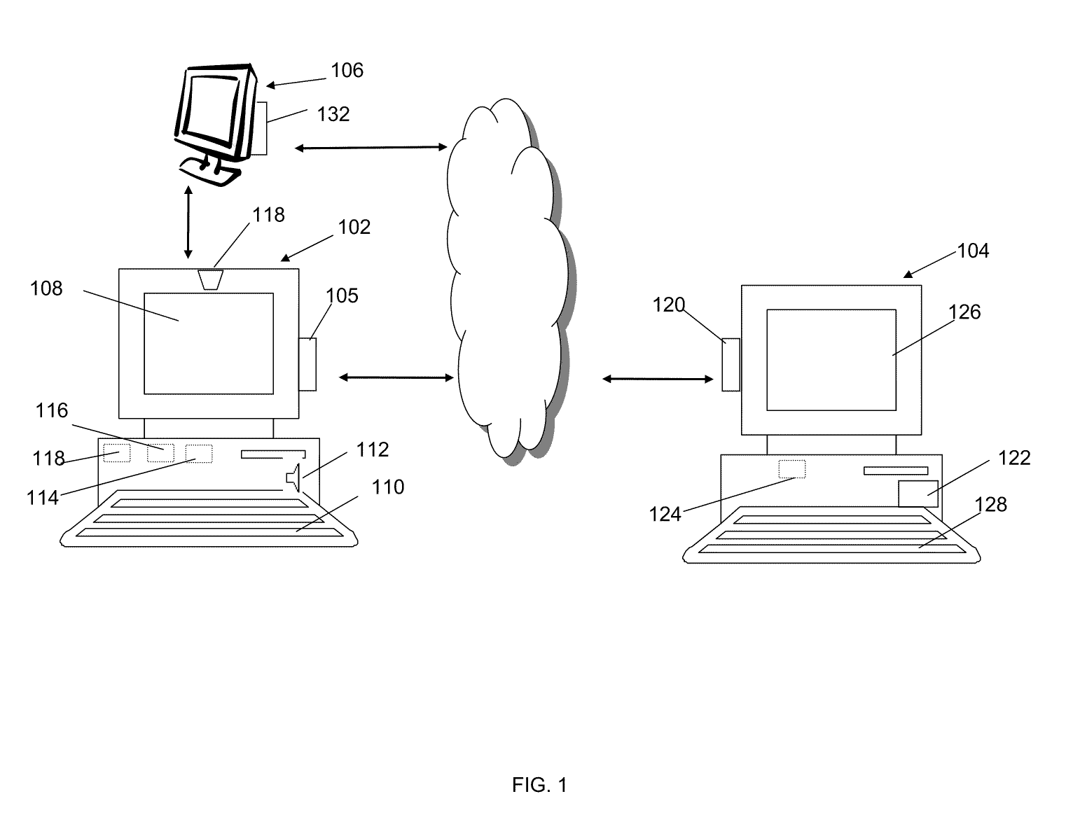

Referring to FIG. 1, according to embodiments, Point-of-Sale system 102 customer Relationship Management system 104, and/or a display 106 can communicate using standard data transmission techniques. For example, Point-of-Sale system 102 customer Relationship Management system 104, and/or a display 106 can communicate wirelessly, via wired communication, and/or a combination of wired and wireless communication. Data, described below in greater detail, can be transmitted between Point-of-Sale system 102, Customer Relationship Management system 104, and/or display 106. Further, display 106 can show offers that are selected based on data. Display 106 can be in communication with Point-of-Sale system 102 and/or Customer Relationship Management system 104 such that offers can be transmitted to display 102 from Point-of-Sale system 102 and/or Customer Relationship Management system 104 and the offers can be shown on display 106. It will be understood that display 106 can be substantially part of Point-of-Sale system 102 and/or a separate unit from Point-of-Sale system 102.

As shown, Point-of-Sale system 102 can include, but is not limited to, a data transmitter 105 (e.g., a wireless transmitter, a wire based transmitter, etc.), a graphical user interface 108, a user input 110, a speaker 112, a processor readable memory 114, a processor 116, a camera and/or scanner 118, and any other reasonable components for use in transmitting/receiving data packets, storing data, and processing any form of information (e.g., data). In some instances, graphical user interface 108 and user input 110 can be substantially the same. For example, graphical user interface 108 and user input 110 can be combined as a touch display (e.g., a display that can detect the presence and location of a touch within the display area). Further, in some instances Point-of-Sale system 102 can include a location tracking device 118, such as a global Point-of-Sale system, WiFi, and/or RFID transmitter/receiver.

It will be understood that Point-of-Sale system 102 can be a cash register, can be affiliated with a cash register, and/or any combination thereof. At times, the language Point-of-Sale system and/or cash register is used in different contexts. This is merely for ease and is in no way meant to be a limitation. Further, Point-of-Sale system 102 can include an order entry system. The order entry system can be any system that can read in and/or has orders entered into it. This order entry system can be used to generate and/or communicate data relating to orders, purchases, and/or transactions. It will be understood that the order entry system can be system affiliated with the Point-of-Sale system, can be substantially a part of Point-of-Sale system 102, and/or any combination thereof. At times, only the Point-of-Sale system and/or the order entry system is referenced, this is merely for ease. In no way is this meant to be a limitation.

Further, display 106 can include any of the elements of Point-of-Sale system 102. For ease display 106 is illustrated as only being a display with a transmitter 132. This is merely for ease and is in no way meant to be a limitation. Further, display 106 and/or Point-of-Sale system 102 can include speakers (not shown) that can be flexible and can fit different sized Point-of-Sale Systems and/or displays.

According to embodiments, Customer Relationship Management system 104 can include, but is not limited to, a data transmitter 120 (e.g., a wireless transmitter, a wire based transmitter, etc.), a processor readable memory 122, a processor 124, a graphical user interface 126, a user input 128, and any other reasonable component for use in a transmitting/receiving data packets, storing data, and processing any form of information (e.g., data). In some instances, graphical user interface 126 and user input 128 can be substantially the same.

According to embodiments, a plurality of Point-of-Sale systems, displays, and/or Customer Relationship Management systems can communicate. Further, data may be stored, transmitted/received, and/or processed on any plurality of Point-of-Sale systems, Customer Relationship Management systems, and/or displays. For example, the Customer Relationship Management system, Point-of-Sale system, and/or display can include a plurality of subsystems, such as, but not limited to, a decision subsystem and/or content subsystem. The decision server can include information from various sources information such as, but not limited to an SAP database, an Amdocs Customer Relationship Management system database, a Warehouse database, Business to Business database, and inventory database, to name few. The content subsystem can be designed to communicate content to any planarity of displays 106 and Point-of-Sale system 102. It will be understood that any of the descriptions referring to elements of and/or functionality of the Customer Relationship Management system and Point-of-Sale system can be included in any subsystem of the Customer Relationship Management System.

According to embodiments, an application layer system can include processor readable information that can be stored, alone or in combination, in processor readable memory 114 of, and/or processor readable memory affiliated with, Point-of-Sale system 102; in processor readable memory 122 of, and/or processor readable memory affiliated with, Customer Relationship Management system 104; in processor readable memory of, or processor readable memory affiliated with, display 106; and/or any other reasonable form of processor readable memory capable storing the application layer system. Further, if data is available to the application layer system, the data can processed by a processor, stored on processor readable memory, and/or communicated by transmitter. It will be understood that the application layer system can be one and the same as, affiliated with, and/or run the weighted scale algorithm and/or the rules based decision algorithm. For ease, at times only the application layer system is described with or without reference to the weighted scale algorithm and/or rules based decision algorithm. This is merely for ease and is in no way meant to be a limitation.

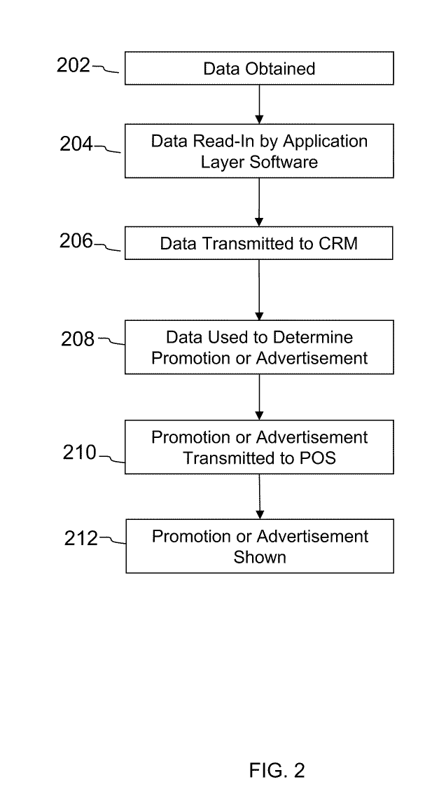

Referring to FIG. 2, in exemplary embodiments, the application layer system can read in and communicate data relating to a purchase at Point-of-Sale system 102 to Customer Relationship Management system 104 and that data can be used to determine an offer to be shown at Point-of-Sale system 102. For example, a user can purchase a product and information about that purchase can be obtained by Point-of-Sale system 102, at step 202, and stored on processor readable memory 114 of Point-of-Sale system 102. Application layer system can then read in that data from the processor readable memory 114, at step 204. It will be understood that data can be read in from other sources, as described below. This data can be transmitted using transmitter 105 to Customer Relationship Management system 104, at step 206. At step 208, Customer Relationship Management system 104 can analyze the data received to determine which offer to transmit. At step 210, the offer can be transmitted, via transmitter 120 to be shown, at step 212.

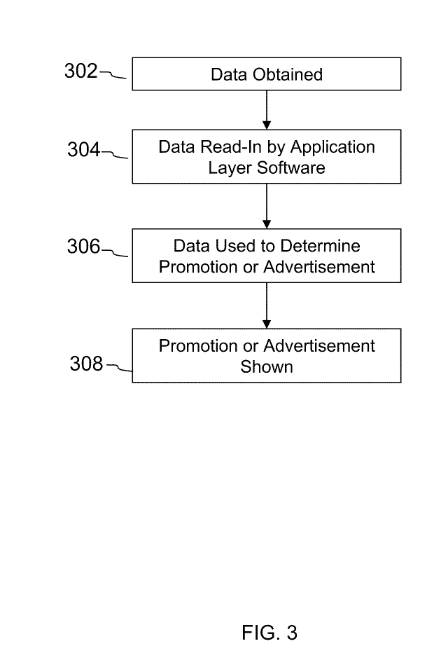

Referring to FIG. 3, in exemplary embodiments, the application layer system can read in data and that data can be used to determine an offer to be shown, for example, at or near Point-of-Sale system 102. For example, the system can be modular and may run on a single computer and/or cash register such as the Point-of-Sale as well as on multiple computers each performing a different task in the system. For example, a user can purchase a product and information about that purchase can be obtained by Point-of-Sale system 102, at step 302, and stored on processor readable memory 114 of Point-of-Sale system 102. Application layer system can then read in that data from the processor readable memory 114, at step 304. It will be understood that data can be read in and/or obtained from any reasonable source, as described below in greater detail. At step 306, the application layer system can analyze the data received to determine which offer is to be shown, at step 308.

The offer can be, for example, a video that can contain audio and/or visual content. For example, an offer can include a sound and/or visual image to attract and/or reinforce an idea to a customer. It will be understood that any reference herein to a video, promotion, offer, advertisement, up-selling offer, new product or service, information and/or anything of the like being displayed can include any form of audio and/or visual content. For ease at times, only the language offer, video, promotion, and/or advertisement is, at times, described as being displayed. This is in no way meant to be a limitation.

It will be understood that the application layer system run on Point-of-Sale system 102 and Customer Relationship Management system 104 can be one and the same or further divided. At times the application layer system run on Point-of-Sale system 102 and Customer Relationship Management system 104 are described as two separate entities. This is merely for ease and is in no way meant to be a limitation.

Data can be obtained from a customer's order at a checkout cash register or other Point-of-Sale device, such as at a location within a store or at a drive through. In some instances, the order can be analyzed by the Point-of-Sale system and/or another location, as described below in greater detail. Further, data can be obtained from additional system, such as, but not limited to biometric systems such as, but not limited to facial recognitions systems, and fingerprinting systems, to name a few; public database, such as, but not limited to, public records, driving records, and real estate record, to name a few; private record, such as, but not limited to, records provided from a private records sources; information collected from social media websites such as, but not limited to, Facebook® accounts, Myspace® accounts, and Twitter® accounts, to name a few; and/or any other reasonable source of data. For example, facial recognition software may be used to gather demographic and/or even unique individual data, including age, sex, weight, dress, etc. Also, Facebook® or other public databases can be used to obtain data such as hobbies, past preferences, etc. Data can be based on past purchases, credit card information, customer name, customer account information, etc. Further, data can be related to demographic data, groups of people, personality type, or any other reasonable technique for relating data. As described below, any of this data can be used in the weighed scale algorithm and/or rules based decision algorithm to determine what offer may be displayed.

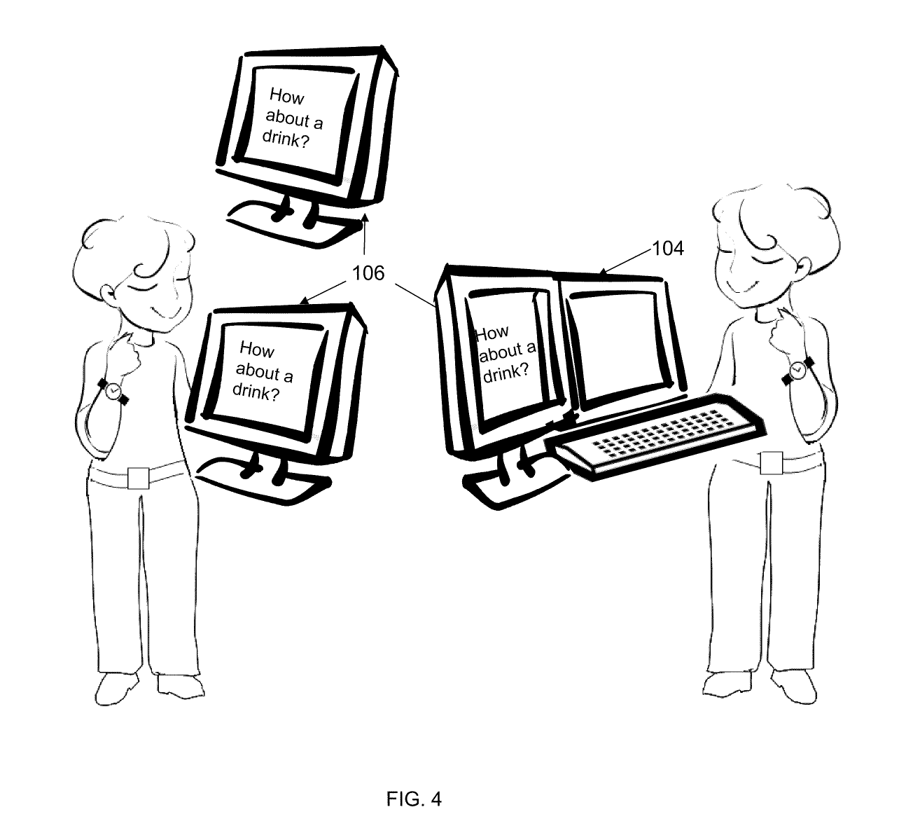

Referring to FIG. 4, an offer for a targeted or “best fit” item, service, etc., can be displayed on a customer-facing display (e.g., display 106), that can be an LCD display, in an attempt to up-sell the order. Other non best-fit up-sells, new products or services, advertising, promotions or other products or services may also be provided. Further, as shown, the offer may also be displayed on a second cashier-facing display. For example, a first display 106 can be located such that a first display can face a user and a second display 106 can face the cashier. This can allow for the synchronization of content, advertising and promotions between the cashier's display and the customer's display information, which can assist the cashier in up-selling, providing further reinforcement of the promoted item(s), services, etc. The cashier's display may include additional information and control features available only to the cashier.

In locations with a more complex sales process, such as in mobile phone stores, auto dealership, banks and other locations where the time spent with the customer can be longer and the number of options for products and/or services is higher, the Customer Relationship Management system can take the customer through the entire purchase and selection process. This may be done on a back-to-back dual-display, or multiple displays, where one side of the display(s) faces the customer service agent, sales representative or other employee or agent and the other side of the display(s) faces the customer. Any alternative number of displays can be used to accommodate the location of the operator of the Point-of-Sale device and the customer being targeted. The dual-display or displays, or alternate number of displays, may include additional information and control features available only to the customer service agent, sales representative or other employee or agent. Displays can be located such that the viewing angle is substantially optimized. In some instances, at least one display can be located above a purchasers.

A display and/or Point-of-Sale system can be capable of generating a sound that can be produced when a cashier or other individual selects to play it and/or a sound can be generated relative to data. This sound can be generated to attract the attention of a purchaser. For example, a cashier can activate a sound when the customer is not looking at the screen, and avoid playing the sound when he is already looking

By way of example, while a customer service agent, sales representative or other employee or agent is pulling up the customer's account, the system can show the customer offers that can be based on their purchase history and current equipment or products and services. At each point of the sales process, whether the customer is looking for additional services, new equipment or products, or repairs, the system can make offers (e.g., purchase suggestions) to the customer as they are taken through the sales process.

In exemplary embodiments, to determine which offer is to be shown, the Point-of-Sale system, Customer Relationship Management system, and/or display can use a weighed scale algorithm and/or rules based decision algorithm. For example, referring to step 208 in FIG. 2 or step 306 in FIG. 3, the Point-of-Sale and/or Customer Relationship Management systems can use a weighed scale algorithm and/or rules based decision algorithm to determine which offer should be displayed on display 106.

In exemplary embodiments, this weighted scale algorithm can be used to determine how often in which order offers may be displayed with respect to each other. In exemplary embodiments, a predefined number of offers can be grouped based on this weighted scale algorithm and offers can be selected from the group by selecting randomly from the group; selecting an offer that is the best fit for that purchaser and/or purchase and/or group of purchasers and/or group of purchases; a combination thereof; or using any other reasonable selection technique. For example, a plurality of promotions can be grouped based on this weighted scale algorithm and from this plurality of promotions a promotion can be selected at random. Further, from a top ten list of promotions, relevant promotions using the weighted scale can be selected randomly rather than merely selecting the top promotion determined to be the most relevant promotion using the weighted scale. It will be understood that this weighted scale can be used with any of the techniques described herein and/or any of the techniques described used a weighted scale algorithm can be used without using a weighted scale algorithm.

In exemplary embodiments, the weighted scale algorithm can determine and/or calculate offers based on any reasonable plurality of variables, such as, but not limited to, data relating to a user and/or group of users; data relating to a purchase, group of purchase; data relating to a product(s); percentage of time between various offers being shown; percentage of showings of offers; relative screen time; or any other reasonable variable. For example, video and audio content for offers can initially be input into a database based upon each possible initial order, that is established manually by a user. The order of appearance of the different offers, based on each possible initial order, can then be input into a database that can be affiliated with the weighted scale algorithm according to an algorithm of weights. By way of example, the algorithm of weights can indicate: the first up-sell will appear 30% of the time; the second up-sell will appear 50% of the time, and; the third up-sell will appear 20% of the time. When these up sells are tied to one or more menu items, their relative screen time can be a function of their relative weight in that menu item(s) up sell chart as above.

In exemplary embodiments, a plurality of offers can be selected for showing to a customer. In exemplary embodiments, an additional offer can be based off of data relating to the purchase, the user, the purchase size, items in a purchase, a cashier input, or any other reasonable method for determining an additional offer. In exemplary embodiments, a plurality of offers can be based on the purchase quantity. For example, if a large order is selected, a plurality of offers can be generated. Further the offer can be based on a specific item ordered in a total order. For example, if a taco is ordered an offer can be selected showing tomatoes and sour cream which may cost an additional amount. Further, when one offer is being shown an additional offer can be triggered based on data and/or a cashier interaction. For example, while a first offer is being shown a cashier can hit “total”, etc., and an additional offer can be displayed and/or can be displayed after a predetermined amount of time. As another example, based on information from the order a second offer can be selected to be shown.

The Point-of-Sale and/or Customer Relationship Management systems can also provide merchants with important statistics and data on their operations that can guide them towards improvement and better understanding of their products, equipment and services. The data can be reviewed with management to improve the results of the Point-of-Sale and/or Customer Relationship Management systems. Further, the Point-of-Sale system can automatically analyze the data for self-improvement of up-selling recommendations, promotions or advertisements based on prior or current input from management and data from the operation of the system. Management can also determine which employees are the best performers from statistics that can be taken from the cash register or Point-of-Sale device (that may have a single display, dual-display or multiple displays) and get feedback on employee performance.

Benefits to merchants from the Point-of-Sale and/or Customer Relationship Management systems of the present invention may include, but is not limited to, an increase in sales and/or increase in average check/ticket/purchase amount on promoted items, a shorter transaction time per customer, a better defined and more consistent sales process (less confusion and better perception on the customer's side), and the ability to gather customer data and get feedback on employee performance, improved customer satisfaction, to name a few.

Referring back to FIG. 3, in exemplary embodiment, the Point-of-Sale system may be implemented using an application layer system which can analyze a customer's order taken at the Point-of-Sale device and promotes a “best fit” up-sell item to the customer on a customer-facing cash register LCD, such as that shown in FIG. 4 Further, the application layer system can include a system for interfacing various elements of various systems, such as, middleware which can read in all, and/or a substantial quantity, of the customer's transactional information from the cash register or Point-of-Sale devices. The middleware can be platform agnostic to allow for quick and easy interface of the system with existing or future developed electronic cash registers and other Point-of-Sale devices (e.g., hardware, software, operating systems and communications protocols). That is, because the middleware can be platform agnostic, the middleware can interface with any existing or future developed electronic cash register and/or other Point-of-Sale devices (e.g., hardware, software, operating systems and communications protocols). The middleware can be an intelligent agent/listening device that may be placed on the hosting Point-of-Sale and/or network. The middleware can capture the information it may be looking for and can transmit this information to the application layer system which may be the system that may also run the weighted scale algorithm and/or the rules based decision algorithm. In some instances, the middleware may be platform agnostic and the application layer system may not be substantially platform agnostic.

In exemplary embodiments, the middleware can be platform agnostic such that an assembly of a plurality components may be configured to interface with any plurality of Point-of-Sale devices. The middleware can be platform agnostic because it can include a collection of a plurality of components that when combined are substantially platform agnostic. For example, a Windows® based agent can retrieve data from an SQL server and/or a physical device attached to LPT port, analyzing the postscript sent to the printer. It will be understood that data can be retrieved and/or obtained from any reasonable source such as, but not limited to, processor readable memory affiliated with the Point-of-Sale system and/or other systems; outputs from the Point-of-Sale system and/or other systems, such as, but not limited to, printer ports, communication ports, video and graphics ports, or any other reasonable port; processors affiliated with the Point-of-Sale system and/or other computers; any combination thereof; and/or any other reasonable source for obtaining data.

It will be understood that the application layer system and the Customer Relationship Management System are the same. At times only the application layer system or Customer Relationship Management System is described. This is done merely for ease and is in no way meant to be a limitation. Further, at times the application layer system, Point-of-Sale system, and/or Customer Relationship Management System are described as simple the system. This is done merely for ease and is in no way meant to be a limitation.

In exemplary embodiment, the application layer system can include a rules based decision algorithm that can allow (and disallow) offers. For example, as described herein, offers can be shown based on various times of the day and/or other time related data.

In exemplary embodiments, the rules based decision algorithm can be used to determine which items to offer, for example, as up sells and the weighted scale algorithm can be used to determine the number of appearances for each. It will be understood that the weighed scale algorithm and rules based decision algorithm can be combined and/or further divided without deviating from the scope of the invention. For ease, at times, only reference is made to the weighed scale algorithm and/or rules based decision algorithm. This is merely for ease and is in no way meant to be a limitation.

The application layer system can determine the “best fit” promotion that may be substantially likely to result in an increased sale and/or non best-fit item (e.g., such as the example offered above for expiring inventory, etc.) based on: management's input on the more effective offers, based on the customer's initial order or external variables such as time of day, time of the year, weather (e.g., based on zip code and RSS feed), the age of the buyer, based on information about the purchase that can be used to provide information (e.g., ordering from the child's menu to indicate age), the amount of people in line, etc. When the orders come in from an electronic cash register or other Point-of-Sale device, the application layer system can determine that there is a short time delay between these orders and that the cashier, sales representative, customer service agent, etc. are substantially busy, and the system can go into a default mode. In default modes, instead of analyzing a customer's order and offering them an offer, the application layer system can play a repeating loop of the most popular items, promotions or advertisements on display devices, such as a customer-facing LCD at a cash register, until the time interval between orders increases to a pre-defined interval. Another way to go into default mode can be by setting a simple time of day, such as lunchtime, during which time the system may play a repeating loop of the most popular items, advertisements or promotions.

In some instances, when the up-sell or other offers are not performing (e.g., selected by a purchaser, group of purchasers, etc.) above a pre-determined level, the data may be analyzed and the up-sell combinations can be reset. This can be done manually and/or be set to happen automatically. Statistics can be collected and reports may be generated according to sales and can be in conjunction with the rules applied before, during and/or after performing the analysis.

The application layer system can be able to dynamically present to the customer video content, such as an advertisement or promotion, based on the unique combination of the customer's existing order and the item(s) most likely to result in an up-sell. Further, an advertisement or promotion can change based on any of the techniques described herein.

The application layer system may also present content for a non best-fit item, such as new product or service offerings, promotions for up-sell items located near the cash register, promotions on items approaching their expiration data, promotions for on-sale items, items offered as a gift or discount based on the client's total payment, co-marketing promotions with other companies, and loyalty programs, to name a few. The application layer system may also have the ability to display options to join customer loyalty programs, payment and credit options, involvement and contribution to the community, and employee of the month, to name a few.

Customer orders, advertisements, promotions, new and existing products, services and equipment may be stored in a database on a server. The combinations of advertisements, promotions, etc. and the customer's order can be dynamically created and may be displayed on a customer-facing display at the cash register or Point-of-Sale device.

Creating an up-sell recommendation system based on video contents may require a clip database comprised of a substantially large number (e.g., hundreds or thousands, millions, etc.) of different items matching the different recommendations. To avoid the need to create a huge library of clip data, the database can include pre-prepared video templates and/or images which can be assigned to different up-selling and/or other recommendation segments. The application layer system may also have the ability to use a decision making algorithm that can pull recommendation-relevant-text from a (recommendation producing) database and corresponding images thus producing dynamically a Flash, HTML or other video in a best-fit or other match to that specific recommendation. This capacity can enable substantially large content diversity and/or best fit value, while offering responsiveness and flexibility which may not be dependent only on “sealed” ready to broadcast existing items. It will be understood that the decision making algorithm can be one and the same as, affiliated with, and/or run the weighted scale algorithm. For ease, at times only the decision making algorithm is described with or without reference to the weighted scale algorithm. This is merely for ease and is in no way meant to be a limitation.

The Point-of-Sale and/or Customer Relationship Management systems may also interface with the inventory, billing, product catalog or other systems in target markets. This can enable an additional level of dynamic interaction with the customer which may also take into effect local market conditions at various locations, for example, within each store. As compared to traditional solutions which may load all advertisements and promotions onto a playlist and display this content in a repeating loop, the system can have a dynamic advertising and promotions component that can be able to automatically and dynamically add or delete advertisements or promotions based on changing market conditions and inventory.

The Point-of-Sale and/or Customer Relationship Management systems can be able to automatically update an offer based on product information. For example, a dairy section of a supermarket can have very perishable food items, such as milk. The database may include a template for the dairy section as well as the branded look and feel for the merchant. A user (e.g., manager, owner, etc.) can be able to define which items can be offered dynamically in promotions (such as milk) and at what discount. For example, when milk is put into inventory in the local supermarket, the bar code may be scanned. From this information the system can read the data, such as the type of product, the size (e.g., 1 gallon), price, brand, expiration date, etc. The system can be able to determine that the milk will hit its expiration date, for example, in two days, and can then automatically add a promotion to the playlist to show the promotion for the milk on the display(s), such as an LCD display, plasma display, etc., in the dairy section. In another example, if a store is running a promotion on designer jeans and the system determines that the designer jeans are out of stock, it can dynamically remove the promotion from the playlist until the jeans are back in stock.

The transactional and up-sell information gathered by the system can also be used as a statistical tool for real time management by the merchant. For example, the collecting of relevant customer data to determine which product combinations and up-sell offers work substantially better than others.

The middleware can be an intelligent agent (driver)/listening device that may be installed on most types of electronic cash registers and Point-of-Sale devices. This intelligent agent can be responsible for extricating all of the transactional information from the cash register or Point-of-Sale devices dynamically in real-time from any RAM I/O (or other data capture method listed below). Older models of electronic cash registers and Point-of-Sale devices may require either the installation of a network interface card (NIC) or the use of a separate computer to be able to install this agent, as well as communicate with the cash register to analyze and offer the customer an up-sell promotion, advertisement of other promotion. Since the agent can be able to pull the data from the existing electronic cash registers or Point-of-Sale devices, this may eliminate the need to replace current Point-of-Sale system affiliated with cash registers or Point-of-Sale devices for the Point-of-Sale or Customer Relationship Management system.

In exemplary embodiments, data can be obtained from various sources. For example, data can be obtained from various sources in the Point-of-Sale system, such as, but not limited to, databases, file systems, hard drives, other data repositories, memory, and RAM, to name a few. By way of example, data can be captured from RAM by listening to data temporarily written to it. This information can be temporary and may be quickly replaced by other written data which may also be captured.

In exemplary embodiments, the application layer can be affiliated with a specific Point-of-Sale system and integrated with it. Data can be also be captured and/or transmitted via RS232, or any other transmitting technique. Data can be organized in, for example, a string that may include data per item bought and/or that data included name, code, quantity and/or price. The string format can be a text line. Further this string can also include at least one text line and/or include item code, quantity, the position in order, price and tax, etc.

The middleware, which can be compatible with various operating sysems (e.g.' DOS®, ^{W}indows®, Linux® etc.) and hardware, intercepts the access to the memory, and in real time, copies the data to the designated location where it is handled. The middleware can record all, or a substantial amount of, the data sent to various sources in the Point-of-Sale system, such as, but not limited to, databases, file systems, hard drives, other data repositories, memory, and RAM, to name a few. The data can be sent, asynchronously to the application layer system. Once the data reaches the application layer system it is transformed into a standard internal protocol. The standardized data may be sent to the decision server, which may be the content and statistical algorithm of the application layer system that can make decisions in real time based on predefined rules to create substantially more effective up-sell promotions or other relevant promotions from promotions stored on, for example, the content server. The data can be stored in a database on servers for reports and statistics. Daily, weekly, monthly, yearly and the like reports can be available for measuring the results of the content, rules, and sales. The Point-of-Sale, the decision server, content server, I/O device, and display may communicate through direct connection, through a network, or over the Internet.

The interfaces may use various data formats for communications and integration, such as plain text, ASCII, HTML, XML, and the like. The output from the electronic cash register or Point-of-Sale device can be done over various means of communication protocols, such as TCP/IP, R^{S}232, Bluetooth®, etc. On some cash registers, Point-of-Sale, or other similar devices, the middleware and decision engine can be installed using two or more display card(s) to encapsulate substantially the entire solution into one computer.

The system can also extract data from an electronic cash register or Point-of-Sale or Customer Relationship Management system in other ways. For example, data may be retrieved from a file or database (such as Access, SQL server, etc.) created by the Point-of-Sale or Customer Relationship Management system, and the present invention can, in an embodiment, query this data and use it. The data may be retrieved by direct integration with the vendor of the Point-of-Sale or Customer Relationship Management system, in which case the system can have a predefined protocol to use, and public objects and methods provided through which the vendor transfers the data. The data may be retrieved from an optical image or display shoot using Optical Character Recognition or Facial Recognition (OCR and Facial Recognition). The data may be retrieved from memory units (memory cards, RAM, etc.) or intercepted while it is being written to or read from the memory. The data may be retrieved by intercepting I/O to external devices such as printers or displays.

This process may be substantially quite complex and cumbersome without such a middleware solution. For example, there are multiple hardware and software Point-of-Sale vendors, as well as several operating systems (each which may have different systems and release versions) and communications protocols used by these systems, and it may be substantially time consuming and expensive to create a Point-of-Sale interface with a merchant using a substantially large number of electronic cash registers and Point-of-Sale devices supplied by, for example, multiple vendors. The alternative of replacing all of the electronic cash registers and Point-of-Sale devices used by a merchant also may be cost inhibitive.

The Customer Relationship Management system can use the data to dynamically create an end-to-end sales process. This sales process can make the recommendations for up-selling at any number of steps during the sales process which may result in an increase in sales for the merchants. The narrowing of offers may reduce customer confusion and can result in a shorter transaction time per customer. This can improve customer satisfaction and may reduce the cost to service each customer.

An exemplary listing of steps that may be used in identifying a customer and organizing a substantial amount of data relating to: past and existing purchases, products, services, etc., can include, but is not limited to:
a. Client arrival recognition (check in with cashier, customer service agent, sales representative, etc. or on touch display device, PC like device or other method).
b. Client departure recognition.
c. Client characteristics recognition.
d. Contents for display recognition and their characteristic (often means assigning client “classifications” and what ads, promotions or other offers the customer should see based on their customer classification.
e. Proper display of different contents (files & different software) including Video & Audio.
f. Display of client fitted recommendations—animated text on a template matching the type of recommendation.
g. Display of web pages in the following manners:
   1. Static URL defined on a button in the application (configurable—for example a cell phone's operations instructions page from a retailer, automotive, banking, etc. website), or
   2. Dynamic URL received from retailer, automotive, banking, etc web service (for example: a statistical distribution of calls).
h. Display of a document that can be signed digitally (for example: a contract during a business transaction which is signed on the client display or on the second display for the cashier, customer service agent, sales representative, etc.).
i. Display of a scanned document (e.g., PDF).
j. Display of a scanned document (by logging on to a web system. For example: archived documents).
k. Display of customer invoices, last invoice & history (e.g., PDF).
l. Display a display of customer service usage distribution (web system).
m. Display files from designated folders (local or web).
n. Support diverse files (e.g., PPT, SWF, DOC, PDF).
o. “Burst” recognition & display of files if defined so.
p. Recognition & display of files as single or multi-appearance items if so defined by retailer, automotive, banking, etc.
q. Display of every pre-defined “as open for view” software\system\display to customers
r. Display of Catalog items from retailer, automotive, banking, etc. Internet website addressing customers preferences, inventory check, credit control simulator and the presentation of the selected set on the customer's display.
s. Display content with or without sound. Videos with original sound must be displayed fully audio-video synchronized.
t. Receive instructions for retailer, automotive, banking, etc. systems on items for display—consecutive active operation of a web-service type sampling interface receiving relevant information from the retailer, bank, automotive, etc., such as: customer data & segment, recommendations for display, instruction for the initiation of a customer service session, URL address for presentation, end of customer service session and any other instruction so defined.
u. Proper display of contents on the customer display even if the resolution from the service person's display is different.

Now that exemplary embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

What is claimed is:

1. A method for processing orders at a Point-of-Sale device, comprising:
providing a Point-of-Sale Device comprising:
an order entry system that can receive the orders,
a processor that can process data related to the order, and
at least one display facing the purchaser; and
wherein an order is entered using the order entry system and the order is analyzed to determine at least one offer that is displayed on a display facing the customer.

2. The method of claim 1, wherein the offer is at least one of an up sell, advertisement, new product or service, information and promotion.

3. The method of claim 1, wherein the offer is determined using at least one of a weighed scale algorithm and rules based decision algorithm.

4. The method of claim 3, wherein the at least one of a weighed scale algorithm and rules based decision algorithm groups a predetermined number offers based on at least one of purchaser data, purchase data, relative times between offers, public records, and private records.

5. The method of claim 4, wherein the offer displayed is selected from the group of a predefined number of offers by determining the best fit.

6. The method of claim 4, wherein the offer displayed is selected from the group of a predefined number of offers by selecting randomly from the group of a predefined number of offers.

7. The method of claim 3, wherein at least one of the weighed scale algorithm and rules based decision algorithm determines which offer to display by analyzing the relative display time of offers to determine what offer to display to the customer.

8. The method of claim 3, wherein at least one of the weighed scale algorithm and rules based decision algorithm determines which offer to display by analyzing display times of offers and information pertaining to the type of purchase/good.

9. The method of claim 1, wherein offer acceptance data is generated relative to whether or not purchaser(s) accepted the offer.

10. The method of claim 9, wherein the offer acceptance data is analyzed to modify at least one of the weighed scale algorithm and rules based decision algorithm.

11. The method of claim 1, wherein the offer includes a sound generated to get a purchasers attention.

12. The method of claim 1, further comprising:
at least one display facing a cashier that displays the offer to the cashier.

13. The method of claim 1, wherein the offer includes at least one of audio and video content to attract the customer's attention.

14. The method of claim 1, wherein at least one of data affiliated with the order and the offer is analyzed, by a processor, to provide statistical data relating to at least one of a plurality of orders and a plurality of offers.

15. The method of claim 1, wherein at least one of data affiliated with the order and the offer is analyzed to increase purchases.

16. The method of claim 3, wherein at least one of data affiliated with the order and the offer is analyzed, by a processor, and this analyzed data is used to update at least one of the weighed scale algorithm and rules based decision algorithm.

17. The method of claim 16, wherein the data is analyzed using at least one of statistical data, data from a third party, and purchase data.

18. The method of claim 1, wherein at least one of data affiliated with the order and the offer is analyzed to determine a cashier's performance in having products purchased.

19. The method of claim 1, further comprising:
establishing a predetermined threshold for a set number of purchases in a set amount of time between a plurality of purchases at the Point-of-Sale device;
analyzing the number of purchases and the time between a plurality of purchases to determine if the predetermined threshold has been exceeded; and
wherein when the threshold is exceeded the Point-of-Sale device stops displaying offers based on orders.

20. The method of claim 1, wherein the rules based decision algorithm determines the type of offer and the weighted scale algorithm determines the number of times the offer is displayed.
